(19) United States
(12) Patent Application Publication
(10) Pub. No.: US 2006/0282292 A1
(43) Pub. Date: Dec. 14, 2006

(54) Healthcare informed consent system and methods

(75) Inventors: Susan G. Brink, Washington, DC (US); Eric Delente, Frederick, MD (US); Ann McFarren, Washington, DC (US)

Correspondence Address: Greenberg Traurig, LLP, 12th Floor, 1750 Tysons Boulevard, McLean, VA, 22102, US

(73) Assignee: HealthMark Multimedia, LLC, Washington, DC (US)

(21) Appl. No.: 11/125,310

(22) Filed: May 10, 2005

(51) Int. Cl. G06F 19/00

(52) U.S. Cl. 705/3

(57) ABSTRACT

A system and methods for creating electronic informed consent documents regarding a healthcare-related research study. Such informed consent documents can include multimedia content to help the prospective participants make an informed decision as to whether or not to participate in the study. In addition to providing easy to understand information about the study, the system can allow prospective participants to store questions and notes, to take one or more tests to assess their understanding of the study, and to walk through a set of psychological, physical, and environmental issues that can help them better assess whether to participate in the study.

### FIELD OF THE INVENTION

The present invention relates to the field of healthcare information systems, and more specifically provides a system and methods through which clinical investigators can create multimedia informed consent presentations, and through which patients interested in participating in a clinical trial can obtain information about the trial and provide informed consent prior to participating in the trial.

### BACKGROUND OF THE INVENTION

Clinical trials have become an increasingly important component of medical research, especially with respect to new drugs and other disease treatments. Clinical trials require the participation of subjects who have a given disease or ailment (referred to herein collectively as “disease”) and who are willing to undergo the new treatment. Often, clinical trial participants are drawn to a trial because of the lack of progress with their medical condition. For others, personal reasons, such as altruism or the desire to receive state-of-the-art care at little or no cost, motivate participation.

To help prospective participants understand the nature and purpose of the research project, the research methods that will be used, the risks and benefits of participation, and to make sure the subjects understand that they are volunteering to be part of a research project, these prospective study participants are given information about the research project through an informed consent procedure. Most federal agencies that are involved with medical research, including the National Institute of Mental Health (NIMH), National Institutes of Health (NIH), and Food and Drug Administration (FDA) have issued guidelines outlining what they consider to be proper informed consent procedures.

The Belmont Report: Ethical Principles and Guidelines for the Protection of Human Subjects of Research, issued by the National Commission for the Protection of Human Subjects of Biomedical and Behavioral Research (1979), addresses ethical principles that the scientific community felt should be applied to human research. The standard elements of informed consent promulgated by the various federal agencies proceed from these principles (see, for example, Code of Federal Regulations 1994). The standard informed consent elements include a statement of the research purpose and procedures; a description of potential risks, benefits and any compensation for injury; disclosure of other possible treatments; statements regarding the confidentiality of data and voluntary participation; and any additional safeguards for vulnerable populations. Prospective patients should also receive contact information for scientists or other researchers who can further describe the research and the prospective participants' rights in the study.

Currently, prospective study participants are given study-related information in written form. However, this information is usually written by a principal investigator (“PI”) or other researcher, with little attention to readability or understanding, especially for those who may not be familiar with standard research and medical terminology. Not surprisingly, several reports on study participant comprehension, recall, and competence for providing informed consent indicate that study participants have difficulty understanding and remembering the information as it is currently provided to them (Agard et al. 2001; Yuval et al. 2000; Verheggen et al. 1995).

One approach to assessing prospective research study participants' understanding of various aspects of the clinical trial is through a questionnaire addressing different objective and subjective issues (Joffe et al. 2001). Yuval and colleagues (2000) found that less than a third (31%) of participants reported full comprehension of the research protocol. This finding is substantiated by other research showing significant percentages of participants indicating less than full comprehension. Tindall and colleagues (1994) reported that 44% of participants stated that they did not understand all of the information provided in a typical informed consent document. In a survey of 26 clinical trials, a large percentage of participants reported a marked lack of understanding in several areas. Many participants (57%) were unaware that the treatment they were undergoing was part of a clinical trial. Most participants did not know either the level of clinical trial in which they were participating (75%) or the study design being used (99%), the level of personal effort involved in participation (59%), or possible alternatives to the trial treatment (70%) (Verheggen et al. 1995). Participants also were unaware of the possible side effects to the experimental treatments. Cancer patients may be especially susceptible to lack of attention since they may view the trial as their “only chance” or the best that medicine has to offer them.

To counteract these informational shortcomings, in an ideal setting physicians and researchers would spend time discussing the research with prospective participants, carefully explaining the study and ensuring comprehension of the research protocol and the personal risks and benefits. This would allow potential study participants to understand the research and its implications for them, and to let the potential participants know what other medical options are available to them. Unfortunately, this can be a time consuming and resource intensive process, and thus it is not done as often as would be otherwise beneficial.

In addition, although it is desirable to have physicians and researchers discuss the study with prospective participants, research suggests that investigators tend to exaggerate the benefits of the experimental treatment and downplay less positive information (Kass et al. 1996; Penman et al. 1984; Rajagopal et al. 1994). Verheggen and colleagues (1995) found that investigators also tend to be skeptical about prospective participants' ability to understand various aspects of study design and implications, such as study type and objective, treatment alternatives, data collection, and confidentiality. Investigators were also reported to de-emphasize these items during the informed consent process (Verheggen et al. 1995).

Physicians also feel, in some cases correctly, that their patients may not desire a great deal of study information (Kass et al. 1996; Verheggen et al. 1995). Thus, they may limit a prospective study participant's exposure to certain types of study information, or predetermine which prospective participants should hear what information (Kass et al. 1996; Verheggen et al. 1995). These physicians make independent judgments about what information to share with a given prospective participant, thereby offering inconsistent information across study subjects (Verheggen et al. 1995).

Despite these shortcomings, it appears that most patients trust their physicians to guide them toward non-harmful medical decisions. In a series of interviews with patients who were participating or had participated in a clinical research study, Kass and colleagues (1996) report that many patients who enrolled in a research study did so because they trusted their physician and the health system to act in the patients' best interest. They were strongly influenced by their physician's recommendation, and they hoped for personal benefit, often feeling that there was no other alternative. In general, patients who chose to participate in a research study reported a trust in the research enterprise to do them no harm. They had often decided to participate before seeing an informed consent document, viewing the research study as another treatment option.

Many potential participants who choose not to participate do so because of distrust of the medical establishment or study methodology. For a variety of well-documented historical reasons, members of non-white and other traditionally underserved populations are less likely to participate in medical research of all types, including clinical trials (McCarthy 1994). Special efforts must be made during the informed consent process to involve and maintain women, children and non-white study participants in clinical trials.

In one study of attitudes toward study participation, only 44% of cancer patients would agree to participate in a study in which two treatments were randomized (Fallowfield et al. 1998). When patients who refused or were uncertain about participation in randomized studies were given further information about the randomization process, a majority of them (68%) changed their minds about participating. Fallowfield and colleagues (1998) identified 3 categories of patients: (1) those who seemed comfortable with the concept of randomization, (2) those who were concerned and needed more information and (3) those who were firmly against the process. It seems clear that prospective participants need carefully explained information to understand the implications of study design, especially the randomization process.

Patients need to understand the trial throughout their participation, not just prior to volunteering. Participants need regular and ongoing access to study information, and each patient's understanding of the research protocol, risks, and benefits should be monitored throughout the study. Implementation research on informed consent indicates that this ideal is not often obtained (Tindall et al. 1994; Verheggen & van Wijmen 1997; Berry et al. 1996).

Delivering the required informed consent information in a way that prospective participants can understand and attend to risks has always been a challenge. Informed consent usually includes a lengthy written document that purports to explain the conduct of the study and the possible risks and benefits. Often these documents are written at a high reading level with extensive use of medical, technical, and study design language that is unfamiliar to lay readers. NIH, NIMH and FDA all have print and Internet material explaining clinical trials for patients (Delaney 1997; NIH 2000; NIMH 2000). This material includes information on the process of informed consent and detailed information on clinical trials and study design. However, the volume of information can be daunting, and the different writing styles and terms can prove very confusing.

Because of the difficulty prospective participants have in understanding documents describing study methodology, attempts have been made to break this out into a separate section or document [Kjaergaard et al. 1998; Kruse et al. 2000; National Cancer Institute (NCI) 1985]. For example, NCI produced a booklet on clinical trials for patients in the mid-1980s (1985). This booklet has seen wide distribution and acceptance with patients and health professionals (Davis et al. 1993). In an evaluation of this booklet with highly educated cancer patients who were eligible for a clinical trial, Davis and colleagues (1993) determined that the booklet increased understanding and knowledge of clinical trials compared to no intervention.

U.S. Pat. Nos. 6,171,112 and 6,149,440, both to Clark et al. (“the Clark patents”), the teachings of which are incorporated herein by reference in their entirety, teach a method and apparatus for authenticating informed consent which attempts to standardize the information presented to study candidates. The methods include presenting a questionnaire to a candidate via a computer screen, and authenticating both the receipt and comprehension of the information. Receipt of the information is confirmed through digital signatures and the use of a video recorder to record the candidate's interaction with the computer. The candidate's comprehension is determined by administering one or more tests regarding the procedure; if the candidate does well, he or she simply digitally authenticates his or her informed consent. On the other hand, if the candidate does not do well, the basic information concerning the procedure is presented to the candidate again. This process is repeated as necessary until the candidate does well on the test.

### SUMMARY OF THE INVENTION

What is needed is a better way for prospective study participants to provide informed consent. By integrating electronic media with traditional written information the information presentation can be standardized and enhanced for prospective study participants with different reading and education levels. Electronic media also provides an opportunity for ongoing assessment of patient understanding (Rangel et al. 2002; Rosoffs 1999). However, clinical trial investigators have not yet made effective use of electronic media in the presentation of informed consent.

Accordingly, the present invention is directed to a system and methods for providing healthcare informed consent that substantially obviates one or more of the problems due to limitations and disadvantages of the related art.

The system and methods described herein were created to assist clinical trial staff with tasks involved in creating accurately informative consent documents and related educational material and to help prospective study participants learn about a given trial and make an informed decision.

Electronic consents for clinical trials offer several benefits to the investigators and organizational entities taking part in the trial. For example, trials and investigators are subject to audits of consent forms. Electronic consents are advantageous compared to traditional consent processes because they offer more a comprehensive audit trail and allow for secure storage of the consents. For complex multi-year trials, consents are often changed as new information about the drug or treatment becomes available. Depending on the information, active trial participants may be asked to re-consent. This can be easily accomplished through a variety of means, including, without limitation, specific marking of the updated areas in the consent, inclusion of additional educational information, E-mail contact with the participant, and use of digital signatures for the participant. The maintenance of adequate records for the completion of this process is key, and electronic consents greatly simplify such maintenance. Furthermore, the unbiased and even presentation of key information across prospective participants eliminates a major drawback of the in-person educational approach in that all prospective participants receive the same basic information.

While these advantages may indicate that online consent procedures would be readily accepted, substantial technical barriers remain. The organizational entity must store the trial consents in accordance with the Health Insurance Portability and Accountability Act (HIPAA)-guidelines for storage of healthcare information. In addition, to make the best possible use of electronic informed consents, an electronic signature process should be available. Furthermore, to assure that all participants have access to the appropriate information, participants and prospective participants should be given access to one or more computers throughout the study. The system and methods described herein overcome these barriers and allow organizations participating in clinical trial research to take advantage of electronic consents.

A few reports exist in the academic literature of small evaluation studies or single attempts to create electronic or multimedia informed consent (Fureman et al. 1997; Jimison et al. 1998; Rangel et al. 2002; Rosoffs 1999; Brady 2003). However, no broad-scale attempts at systemizing consent presentation for prospective clinical trial subjects have yet been developed.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

A multimedia presentation of informed consent information would ensure that all prospective and active participants are exposed to the same information. Appropriate use of multimedia techniques will assist with patient learning and competence to provide truly informed consent. Data from a recent test with men with recurrent prostate cancer indicated a significant (p=0.021) pre-to-post change in knowledge about clinical trials. In this test, information was provided on a CD-ROM with audio explanation and accompanying graphics (Birney et al. 2001). The ability to provide prospective and active participants with information through auditory and visual channels (i.e., text with voiceover, graphics with voiceover, video or animation) is the primary strength of a multimedia approach. The addition of audio and visual elements to informed consent documents has been shown to increase participant interest and retention (Fureman et al. 1997; Jimison et al. 1998).

Prospective study participants can also benefit from information presented in “layers” and in a variety of formats (Verheggen & van Wijmen 1997; Jimison et al. 1998). Yuval et al. (2000) reported that patients were more likely to remember oral than written consent information. The use of video in addition to written documents also increased participants' long-term retention of study information (Fureman et al. 1997). Jimison and colleagues (1998) determined that particiants felt less stress and more in control of the process when they used a multimedia informed consent “document.” They liked the use of modules and a hierarchy of information and reported that video segments made the information easier to understand.

Informed consent guidelines dictate that prospective participants should be informed in as unbiased a way as possible. Although a multimedia presentation may never fully replace the personal contact needed to complete an informed consent, its use may minimize certain inherent problems with the informed consent process. By way of example, without intending to limit the present invention, within a given study, the information will be standardized from participant to participant, thus eliminating presenter bias. The use of a number of presentation methods (e.g., narrator, text, video, graphics), alone or in combination, can enhance participant understanding and retention of complex information. The user can be given options, allowing participants to choose their preferred presentation type(s). For example, a participant might choose an animated explanation of randomization in a 2-group clinical trial, followed by a verbal explanation by a doctor or nurse. Or, the participant may prefer to select a simulation in which he or she undergoes randomization into a hypothetical study, followed by a series of questions about his or her reaction to the outcome. For example, how does the participant feel about being in Group C or in the Standard Treatment Group, or the New Treatment Group? A single multimedia product can also be designed to take into account reading level, learning style and primary language. Through the use of embedded review questions, an interactive informed consent can offer periodic automated assessments and feedback regarding prospective participant comprehension as the prospective participant explores the informed consent materials.

One aspect of the system and methods disclosed herein provides an investigator or trial coordinator with a set of templates for uploading information to be formatted into an electronic consent document. The look and feel of the electronic consent document can be customized to the organizational entity or trial group for organizational branding purposes. A dictionary program can identify and supply definitions for standard of key words and phrases that need explanation. Technical staff can work with the trial staff to identify other key words and phrases to be defined. Additional visual, audio, and interactive assets can also be created to accompany the electronic consent document to create a packaged consent document.

Trial staff and organizational Institutional Review Board (“IRB”) members can review the consent at key points during development. When all reviews are completed, the packaged consent document should be placed on secure servers for access by the PI and prospective participants.

Prospective trial participants will be given a card with a subject number or other personal identifier. This identifier will give them access to the specific trial site for which they are eligible, provide tracking information to the trial investigator, and allow the prospective participant to easily re-enter the consent form should they join the trial and need to reconsent. The PI will have a subject-number-coded transcript of all transactions on the site during the clinical trial. CS staff can maintain encrypted associations between study subjects numbers and email addresses or other means of contacting the study subjects. The list of participants and corresponding subject-study number codes will remain with the PI or be stored as required by the IRB.

It is to be understood that the foregoing general description, the usage examples, and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a block diagram illustrating the transformation of a clinical trial consent into a packaged consent document.

FIG. 2 is a screen capture illustrating a sample prospective participant login screen.

FIG. 3 is a screen capture illustrating a sample welcome page and consent document layout.

FIG. 4 is a screen capture illustrating a sample prospective participant note and question screen.

FIG. 5 is a screen capture illustrating a sample prospective participant self test.

FIG. 6 is a screen capture illustrating a sample prospective participant decision tool.

FIG. 7 is a screen capture illustrating a sample section review screen.

FIG. 8 is a screen capture illustrating a sample glossary or dictionary screen.

### DETAILED DESCRIPTION OF THE PREFERRED EMBODIMENT

Reference will now be made in detail to the preferred embodiments of the present invention, examples of which are illustrated in the accompanying drawings.

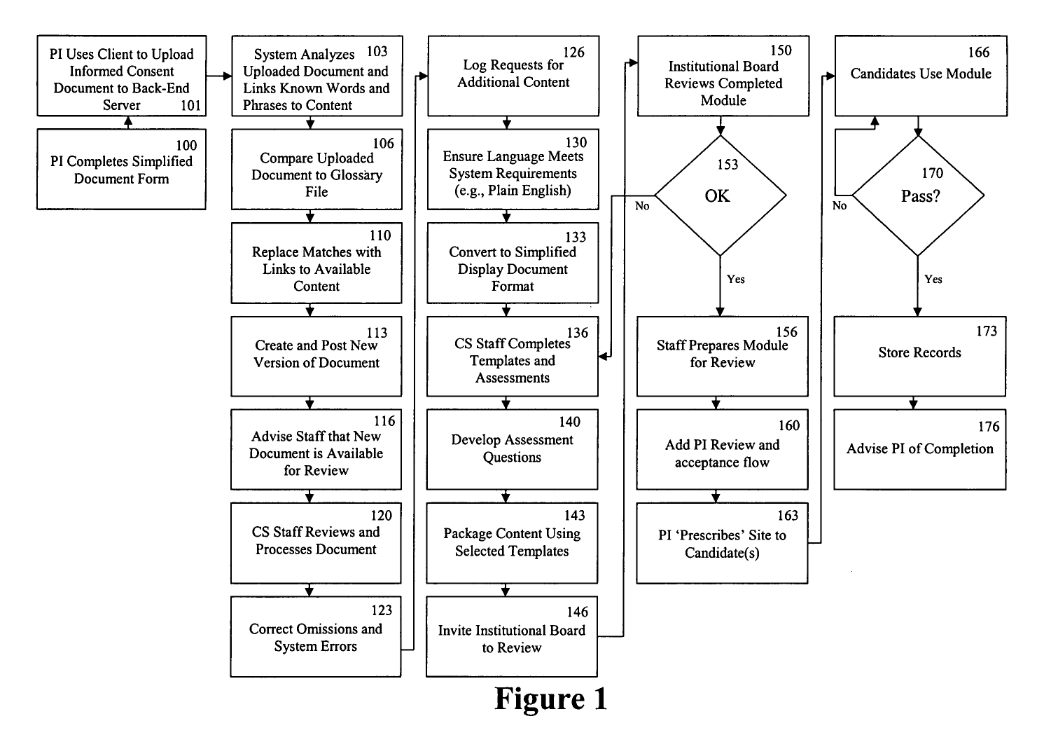

FIG. 1 is a block diagram illustrating the transformation of a clinical trial consent into a multimedia consent document. In a preferred embodiment, the PI first drafts an informed consent document based on a standardized information collection template or form by adding trial specific information (Block 100). In the embodiment illustrated in FIG. 1, all information in the system is created and stored in a relational database with the capability of exporting information into at least one standardized computer language, such as, but not limited to, eXtensible Markup Language (“XML”), HyperText Markup Language (“HTML”), or other language derived from or similar to the Standardized Generalized Markup Language (“SGML”); Microsoft's Rich Text Format (“RTF”); Adobe's Portable Document Format (“PDF”), or the like. Such an arrangement can allow the information to be easily accessed through assigned personal identifiers. In one embodiment, the prospective participant's personal identifier is keyed to appropriate clinical trials. When the prospective participant signs on with the identifier, the information in the database for that trial is unlocked and displayed as a web page. This architecture also increases the scalability of the product and allows elements, including graphic elements for definitions, to be redisplayed and repurposed throughout a plurality of research projects.

The system is preferably designed using a client/server architecture. As should be appreciated by one skilled in the art, the system may be designed as a single-tier architecture or an n-tier architecture, depending on anticipated rates of change for a variety of factors, including, but not limited to, data storage, bandwidth, and computational processing. The system preferably uses at least one HTTP-based front-end server to allow clients to interface with one or more back-end servers. Although described herein as separate servers, it should be apparent to one skilled in the art that the back-end server(s) and the front-end server can be implemented on the same computer, or distributed across a computer grid.

In one embodiment, the back-end servers are responsible for the majority of system-related information storage, processing, and presentation functions. By way of example, without intending to limit the present invention, the back-end servers may include a database server for storing packaged consent documents to be provided to candidates who are considering participating in a particular research program. The back-end servers may also perform candidate and other user identification based on information obtained by the client. The back-end servers can perform such identification using a variety of means, including without limitation assigning a personal identifier and password to each prospective participant or other user, using one or more biometric identifiers to positively identify each user, or combinations thereof. Once a user has been properly identified and authenticated, the back-end servers can provide the user with an appropriate level of access to the information and resources provided by the system.

Clients can be software and/or hardware devices used by a PI, prospective or active participant, or other user involved in the research project. By way of example, such clients may include, but are not limited to, web browser software, such as Internet Explorer, distributed by Microsoft Corporation of Redmond, Wash.; and Netscape Navigator, distributed by Netscape Corporation of Mountain View, Calif., running on a personal computer, cellular telephones, portable digital assistants (“PDA's”), or pagers, or custom software for interfacing with the back-end servers.

The PI's document is preferably uploaded or otherwise electronically submitted to the system's back-end servers via client 101. Although electronic submission is preferred for efficiency purposes, one skilled in the art would appreciate that re-keying a paper document, transcribing dictated information, or other data entry means are also effective means for submitting the information to the back-end servers. For clarity purposes, the system will be described as though the information was uploaded in electronic form.

The system analyzes the uploaded document and inserts links to more detailed information about known words or phrases into the document (Block 103). A glossary is also created which contains definitions of the technical, medical, or other terms not frequently encountered by the general public that are in the document (Block 106). The system then preferably inserts links throughout the document for each of the terms in the glossary (Block 110).

When the system is finished inserting the appropriate auto-generated content, a draft consent document is preferably made available for review by one or more technical (“CS”) staff members (Block 113). For workflow purposes, the draft consent document is preferably assigned to one or more CS staff, who may be advised that the document exists (Block 116). The CS staff can review the draft consent document (Block 120) and make any necessary changes (Block 123).

In some cases, the CS staff may identify portions of the draft consent document for which additional content should be created. The CS staff can request creation of appropriate content, and such content requests may be logged as part of a consent document review process (Block 126). The CS staff may also ensure that only a limited amount of technical and/or scientific language is used in the draft consent document, and can request that some portions be rewritten if necessary (Block 130).

When the CS staff has finished reviewing and adding the appropriate links and content to the draft consent document, the draft consent document may be converted into a simplified display format (Block 133). The CS staff also preferably completes other informational (Block 136) and assessment templates (Block 140) associated with the consent document. Such informational and assessment templates may include, but are not limited to, a patient self test and a decision tool. These informational and assessment templates are described in more detail below. A section review list may also be auto-generated based on information present in the draft consent document.

The draft consent document, the related content, and other informational and assessment templates are then combined into a packaged consent document using the PI's preferred template (Block 143). Once the package is created, the institutional review board (“IRB”) is invited (Block 146) to review the packaged consent document (Block 150) to ensure that it meets the IRB's requirements. If the IRB does not feel that the packaged consent document is acceptable, the IRB's concerns and requested changes may be addressed by the PI. The revised packaged consent document can be resubmitted to the CS staff for additional modification (Block 136). If the IRB approves the packaged consent document, the CS staff may perform another quality assurance check on the packaged consent document (Block 156), and then the packaged consent document can be made available to the PI for the PI's final review and approval (Block 160). Upon final approval by the PI, CS staff can create a set of patient numbers or other user identifiers, together with associated passwords, for that particular packaged consent document. In one embodiment, the number of user identifiers created is in excess of the number of desired patients for the study. This study-specific list can then be transmitted or otherwise distributed to the PI. Unique “Patient Access Cards” may also be created for each user identifier and delivered to the PI.

The PI can then “prescribe” the packaged consent document to a prospective study participant (Block 163) by providing a Patient Access Card to the prospective participant registering biometric information about the prospective participant, or otherwise facilitating access. A prospective participant can then review the packaged consent document and elect whether or not to participate in the study based on information provided to them. If the prospective participant meets the study's requirements and elects to participate (Block 170), their information is stored in the system (Block 173) and the PI is advised that the prospective participant has completed the consent document (Block 176).

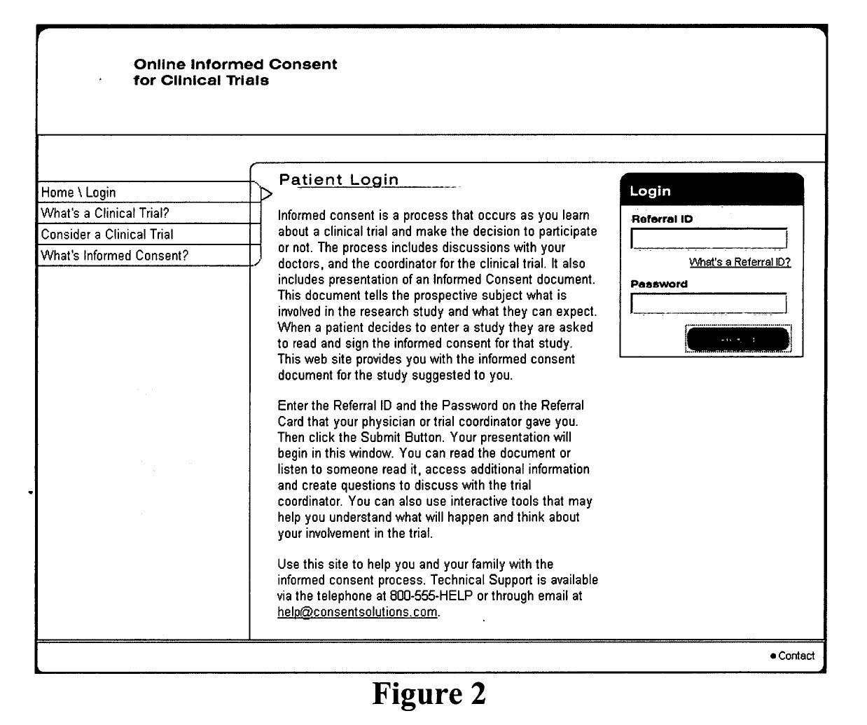

FIG. 2 is a screen capture illustrating a sample login screen. This screen can be used to identify individual participants as they navigate through the packaged consent module. Entry of the assigned user identifier on this screen ensures that the prospective participant accesses the recommended clinical trial if more than one trial is available from a given PI or institution. By identifying individual active and prospective participants, the system can also monitor behavior, monitor performance on assessment questions, save notes, and perform other, individual-specific tasks. Although a participant login screen is presently preferred, in an alternative embodiment, anyone wishing to find out more about a particular research study may be able to access the study-related information without logging in.

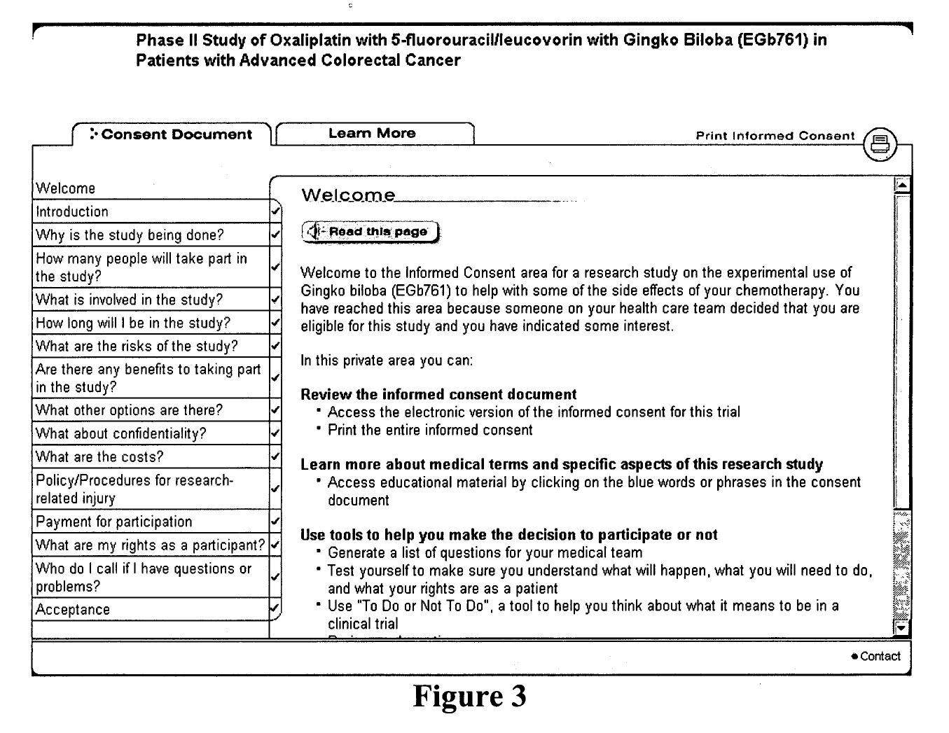

FIG. 3 is a screen capture illustrating a sample welcome page and consent document layout. As FIG. 3 illustrates, a consent document can allow a prospective participant to select from a variety of information about the study, and to go through the information at their own pace. To help participants who are visually impaired, the system may include a recording of a person reading the information contained on a given page, or a text reader may be used to read the information to the participant. In an alternative embodiment, participants may also choose their preferred written and/or spoken language.

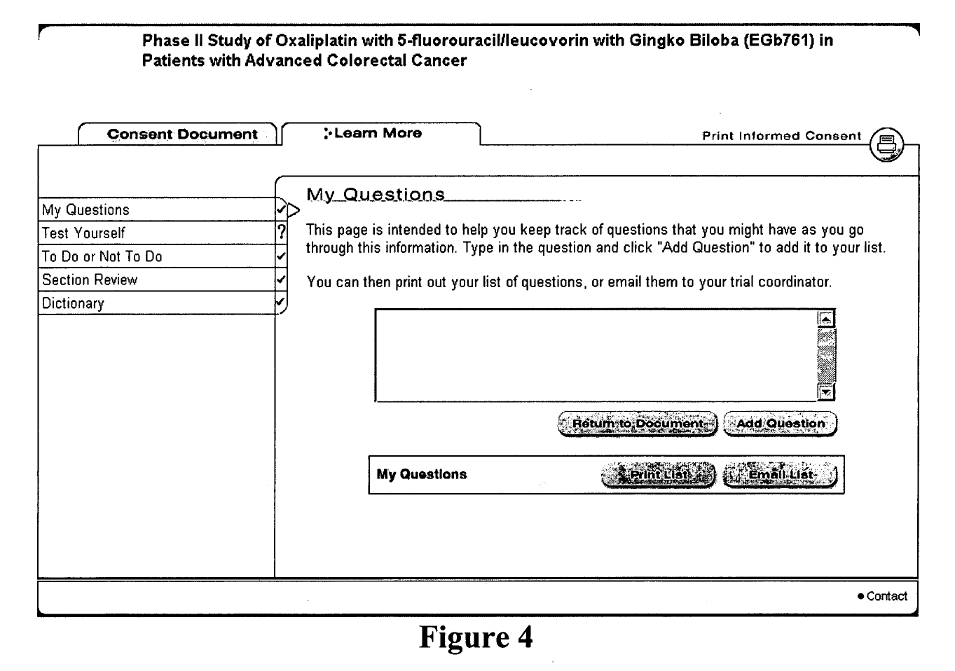

As a participant moves through the consent document, the participant may wish to take certain notes, and may have questions be asked of the PI or their own physician. The system preferably includes a participant note and question screen such as that illustrated in FIG. 4. The participant's questions and notes are preferably stored in the system, and the participant may print them, E-mail them to the PI, a study coordinator, or other entity, or otherwise make use of the stored notes and questions.

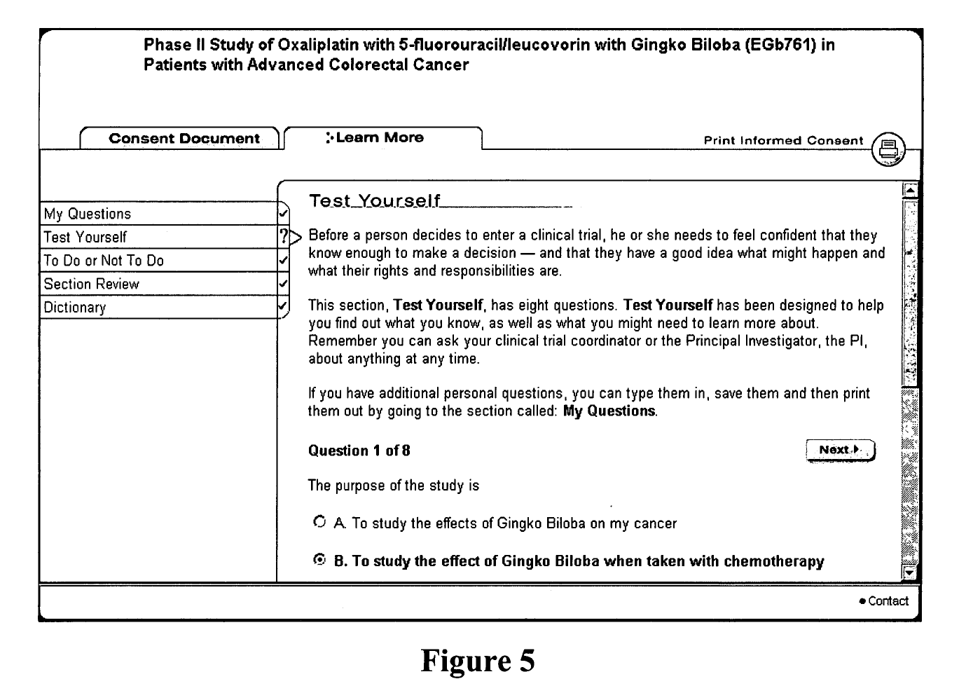

FIG. 5 is a screen capture illustrating a sample participant self test. Participants can test their understanding of the research program by taking the participant self test. The self tests can point participants to specific information about the trial whenever the participant provides an incorrect answer. In one embodiment, multiple self tests are created for each research program, thereby allowing participants to take multiple tests and further enhance their understanding of the research program.

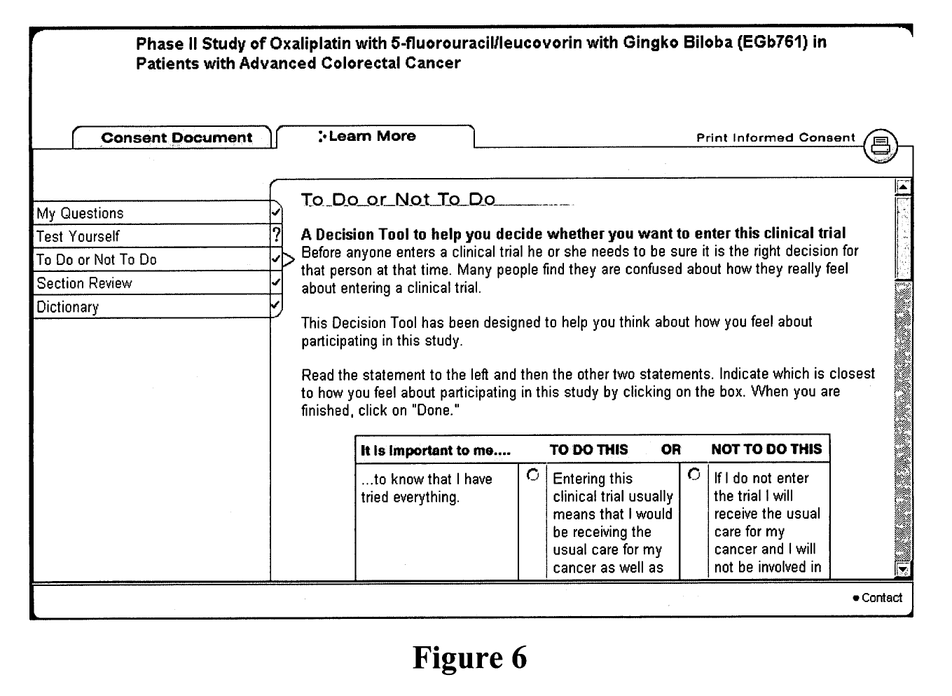

FIG. 6 is a screen capture illustrating a sample decision tool. The decision tool can help a participant determine whether to participate in the research program. In one embodiment, the decision tool may present the participant with a series of psychological, physical, and environmental related questions or issues, and the participant can choose between two or more options. Based on the participant's answers, the system can then provide feedback to the participant as to whether the participant should or should not participate in the research program.

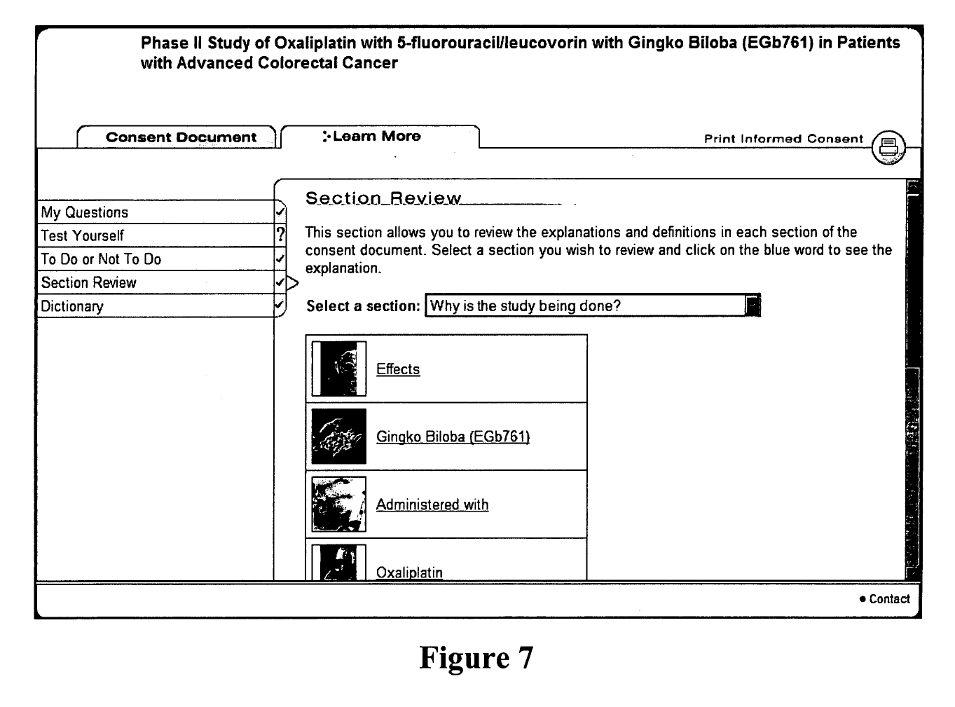

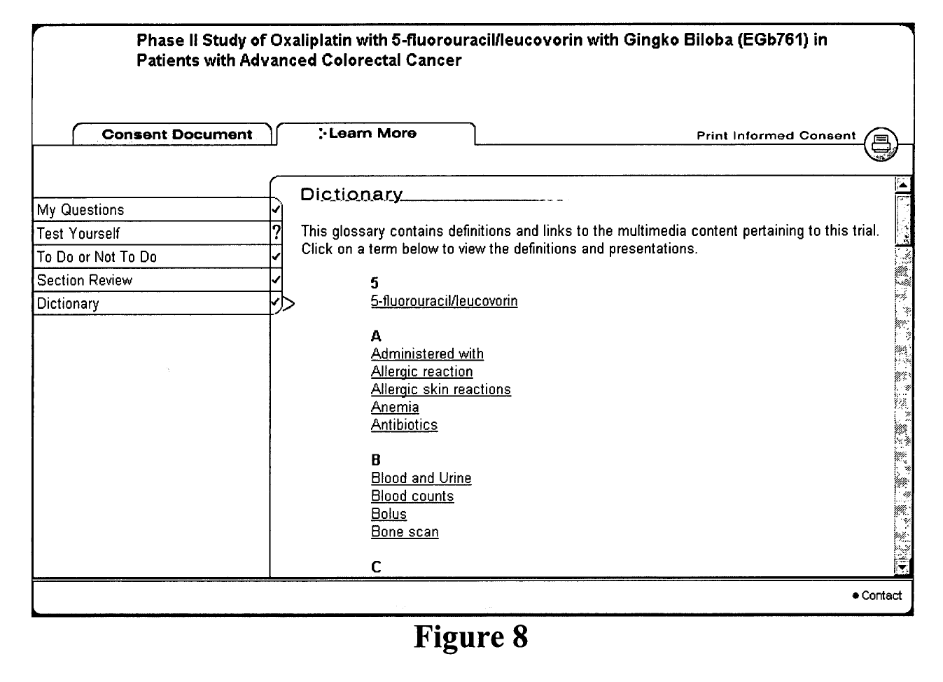

FIG. 7 is a screen capture illustrating a sample section review screen. In a preferred embodiment, a section review screen allows participants to easily access content included in a consent document, without having to scroll through the entire document. Such a review screen may also include some or all of the glossary or dictionary definitions from a given section. In one embodiment, the system includes a separate glossary or dictionary screen, such as that illustrated in the screen capture of FIG. 8.

### REFERENCES

Agard A, Hermeren G, Herlitz J. Patients' experiences of intervention trials on the treatment of myocardial infarction: is it time to adjust the informed consent process to the patient's capacity? Heart 2001; 86(6):623-7.
Berry D L, Dodd M J, et al. Informed consent: process and clinical issues. ONF 1996; 23(3):507-12.
Birney A J, Brink S G, McFarren A E. Recurrent Prostate Cancer: A Decision Support Guide. Final Phase I SBIR Report to NCI. December 2001.
Code of Federal Regulations. 21 CFR, Part 50 (April 1994).
Davis S, Nealon E, Stone J. Evaluation of the National Cancer Institute's clinical trials booklet. JNCI Monogr 1993; 14:139-45.
Delaney P. Understanding Clinical Trials from the Patients' Perspective. October 1997. http://www.fda.gov/oashi/cancer/pdart.html.
Fallowfield L, Jenkins V, Brennan C, et al. Attitudes of patients to randomized clinical trials of cancer therapy. Eur J Cancer 1998; 34(10):1554-9.
Food and Drug Administration (FDA). (September 1998). Clinical Trials of Medical Treatments: Why volunteer? Publication No. 98-1294.
Fureman I, Meyers K, McLellan A T, et al. Evaluation of a video-supplement to informed consent: injection drug users and preventive HIV vaccine efficacy trials. AIDS Education and Prevention 1997; 9(4):330-41.
Jimison H B, Sher P P, Appleyard R, LeVernois Y. The use of multimedia in the informed consent process. J Am Med Inform Assoc 1998; 5(3):245-56.
Joffe S, Cook E F, Cleary P D, Clark J W, Weeks J C. Quality of informed consent: a new measure of understanding among research subjects. J Natl Cancer Inst 2001; 93(2):139-47.
Kass N E, Sugarman J, Faden R, et al. Trust: the fragile foundation of contemporary biomedical research. Hastings Center Report. September-October 1996:25-9.
Kjaergaard L L, Kruse A Y, Krogsgaard K, et al. Outpatients' knowledge about and attitude towards clinical research and randomized trials. The INFO Trial Group. Dan Med Bull 1998; 45(4):439-43.
Kruse A Y, Kjaergard L L, et al. A randomized trial assessing the impact of written information on outpatients' knowledge about and attitude toward randomized clinical trials. Controlled Clinical Trials 2000; 21:223-40.
McCarthy C R. Historical background of clinical trials involving women and minorities. Acad Med 1994; 69(9):695-8.
National Cancer Institute (NCI). (1985). What Are Clinical Trials All About? National Cancer Institute.
National Commission for the Protection of Human Subjects of Biomedical and Behavioral Research. (1979). The Belmont Report: Ethical Principles and Guidelines for the Protection of Human Subjects of Research. Washington, D.C.: Department of Health and Human Services.
National Institute of Mental Health (NIMH). A Participant's Guide to Mental Health Clinical Research. June 2000. http://www.nimh.nih.gov/studies/clinres.cfm.
National Institutes of Health (NIH). What is a Clinical Trial? Oct. 5, 2000. http://clinicaltrials.gov.
Penman D, Holland J, Bahna C, et al. Informed consent for investigational chemotherapy: patients and physicians perceptions. J Clin Oncol 1984; 2(7):849-55.
Rajagopal S, Goodman P J, Tannock I H. Adjuvant chemotherapy for breast cancer: discordance between physicians' perception of benefit and the results of clinical trials. J Clin Oncol 1994:12(6): 1296-1304.
Rangel S J, Narasimhan B, Geraghty N, & Moss R L. Development of an Internet-Based Protocol to Facilitate Randomized Clinical Trials in Pediatric Surgery. J Pediatric Surgery 2002; 37: 990-994.
Rosoffs A J. Informed Consent in the Electronic Age. LexisNexis™ Academic. accessed 8/2002/web.lexis-nexis.com/universe.
Tindall B, Forde S, et al. Effects of two formats of informed consent on knowledge amongst patients with advanced HIV disease in a clinical trial of didanosine. Pt Ed & Couns 1994; 24:261-6.
Verheggen F, Jonkers R, Kok G. Patients perceptions on informed consent and the quality of information disclosure in clinical trials. Pt Ed & Couns 1995; 29:137-53.
Verheggen F, van Wijmen F. Myth and reality of informed consent in clinical trials. Med Law 1997; 16:53-69.
Yuval R, Halon D A, et al. Patient comprehension and reaction to participating in a double-blind randomized clinical trial (ISIS-4) in acute myocardial infarction. Arch Intern Med 2000; 160:1142-6.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A system for providing a prospective participant with information about a study and for
receiving informed consent from the prospective participant, comprising:
client software, wherein the client software runs on a computer operated by the prospective participant;
at least one packaged consent document, wherein the at least one packaged consent document is comprised of multimedia content pertinent to the study, and at least one decision tool;
at least one back-end server, wherein the at least one back-end server stores the at least one packaged consent document; and,
at least one front-end server, wherein the at least one front-end server provides an interface through which the client software can access the at least one packaged consent document stored on the at least one back-end server.

2. The system of claim 1, wherein the at least one back-end server and the at least one front-end server operate on the same computer.

3. The system of claim 1, wherein the at least one front-end server formats the contents of the at least one packaged consent document for presentation by the client software.

4. The system of claim 1, wherein the at least one back-end server formats the contents of the at least one packaged consent document for presentation by the client software.

5. The system of claim 1, wherein the packaged consent document further comprises at least one self test.

6. The system of claim 1, wherein the client software is a web browser.

7. The system of claim 1, wherein the at least one front-end server comprises a web server.

8. The system of claim 1, wherein the at least one back-end server comprises a relational database.

9. The system of claim 1, wherein the at least one back-end server allows portions of a first packaged consent document to be used as part of a second packaged consent document.

10. The system of claim 1, wherein the client software provides an individual identifier to the at least one front-end server.

11. The system of claim 10, wherein the individual identifier is used to control access to information in the back-end server.

12. The system of claim 1, further comprising a prospective participant notes tool.

13. A method of creating a packaged consent document, comprising:
receiving a disclosure document from a user;
uploading the received disclosure document into an electronic system to create a first draft document;
using the electronic system to scan the first draft document and insert links to content about a first set of known words and phrases;
setting the access privileges on the first draft document such that technical staff can access the first draft document;
allowing the technical staff to review and edit the first draft document to create a second draft document;
receiving a set of participant decision criteria associated with the second draft document;
uploading the participant decision criteria into the electronic system and associating the uploaded participant decision criteria with the second draft document; and,
packaging the uploaded participant decision criteria and the second draft document into a packaged consent document.

14. The method of claim 13, further comprising advising technical staff that initial processing of the first draft document is complete.

15. The method of claim 13, further comprising setting access privileges on the packaged consent document such that the user can prescribe the packaged consent document to at least one prospective participant.

16. The method of claim 15, further comprising allowing the at least one prospective participant to evaluate whether or not to participate in the study based on the uploaded participant decision criteria.

17. The method of claim 13, further comprising: setting access privileges on the packaged consent document such that a review board can access the module; and receiving approval for the packaged consent document from the review board.

18. The method of claim 17, further comprising setting access privileges on the packaged consent document such that the user can prescribe the packaged consent document to at least one prospective participant.

19. The method of claim 18, further comprising allowing the at least one prospective participant to evaluate whether or not to participate in the study based on the uploaded participant decision criteria.

20. The method of claim 13, wherein the first draft document and the second draft document are stored as versions of the same document.

21. The method of claim 13, wherein the second draft document replaces the first draft document.

22. The method of claim 13, further comprising compiling a glossary based on a second set of known words and phrases in the first draft document.
